(19) United States
(12) Patent Application Publication
(10) Pub. No.: US 2016/0332858 A1
(43) Pub. Date: Nov. 17, 2016

(54) CAN AND BOTTLE OPENER

(71) Applicant: Maria CAUDLE, Las Vegas, NV (US)

(72) Inventor: Maria CAUDLE, Las Vegas, NV (US)

(21) Appl. No.: 14/704,933

(22) Filed: May 5, 2015

(51) Int. Cl. B67B 7/44; B67B 7/40; B67B 7/16

(52) U.S. Cl. CPC B67B 7/44; B67B 7/16; B67B 7/403

(57) ABSTRACT

A can and bottle opener has a tab engaging cavity in its front end. The cavity has a beveled lower lip which facilitates insertion of the tab of a soup can in the cavity. The top face of the opener has a channel which communicates with a portion of the tab engaging cavity to facilitate seeing the tab in the cavity or, additionally or alternatively, to reduce interference in various ways as the can tab is inserted in the cavity. The opener also has a window near its back end. The top face of the opener has a tooth which projects rearward into the window and can engage the cap of a bottle when the opener is inverted and the top portion of the bottle with the cap is inserted in the window from below.

### TECHNICAL FIELD

The present invention relates generally to the field of household, kitchen, catering and bar items, more specifically to bottle and can openers, especially to a tool embodying elements of a beverage opener and a soup can pull tab opener. In some of its embodiments, the opener is especially suited to opening a pull-tab-equipped soda or beer can.

### INVENTION SUMMARY

It is an object of the present invention to provide an opener for opening beverage and food containers.

In accordance with these objects and with others which will be described and which will become apparent, an exemplary embodiment of the beverage and food container opener has first and second sides, top and bottom faces, and front and back ends, said sides, faces and ends roughly defining a rigid rectangular solid. It has a soup can tab-engaging cavity formed in said front end. It has a channel formed in said top face over said tab-engaging cavity; said channel and said tab-engaging cavity being functional together to lift the soup can tab and facilitate opening the soup can.

The opener in another exemplary embodiment also has a window formed through said opener from said top face to said bottom face proximate said back end, said window having an inward-projecting tooth, said window and said tooth being usable together to pry a cap from a beverage bottle.

The opener may have an eyelet formed from said top face to said bottom face proximate said back end.

At the front end of the opener, the tab-engaging cavity may have a beveled lip for easing the opener onto a soup can tab.

Also in accordance with the present invention, a method of opening a tab-equipped can includes the steps of providing the opener as described above, positioning said tab-engaging cavity about the tab; and rotating said opener until the tab opens the can.

An elaboration on this method further includes the steps of orienting the opener with said channel away from the tab before engaging the opener on the tab and rotating the opener by lifting said back end after said front end becomes difficult to advance any farther relative to the tab.

An alternative elaboration on the same method further includes the steps of orienting the opener with said channel toward the tab before engaging the opener on the tab, advancing the opener until said front end has advanced past the structure that attaches the tab to the can top, and, thereafter, rotating the opener by lifting said back end.

Also in accordance with the present invention, a method of opening a capped bottle includes the steps of providing an opener with a window as set forth above; positioning said window about the cap of the bottle; and rotating said opener until the cap is pried off the bottle.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a perspective view of an exemplary embodiment of a soup can and bottle opener in accordance with the present invention;

FIG. 2 is front view thereof;

FIG. 3 is a top view thereof;

FIG. 4 is a bottom view thereof;

FIG. 5 is a perspective view thereof as seen from above;

FIG. 6 is a perspective view thereof as seen from a side;

FIG. 7 is a perspective view thereof as seen from a side;

FIG. 8 is a top view thereof, engaged on the tab, with the channel facing the can, inverted relative to the orientation shown by FIG. 5;

FIG. 9 is a bottom view thereof with a bottle cap engaged on the opener;

FIG. 10 is a perspective view of a second embodiment of a can and bottle opener in accordance with the present invention;

FIG. 11 is a top view thereof;

FIG. 12 is a bottom view thereof;

FIG. 13 is a left side view thereof;

FIG. 14 is a right side view thereof;

FIG. 15 is a front view thereof;

FIG. 16 is a rear view thereof;

FIG. 17 is a perspective view of the second embodiment of the opener engaged on a can pull tab;

FIG. 18 is a perspective view of the second embodiment of the opener engaged on a can pull tab;

FIG. 19 is a top view of the second embodiment of the opener engaged on the can pull tab; and

FIG. 20 is a top view thereof, engaged on the tab, with the channel facing the can, inverted relative to the orientation shown by FIG. 19.

### DETAILED DESCRIPTION OF THE PREFERRED EMBODIMENTS

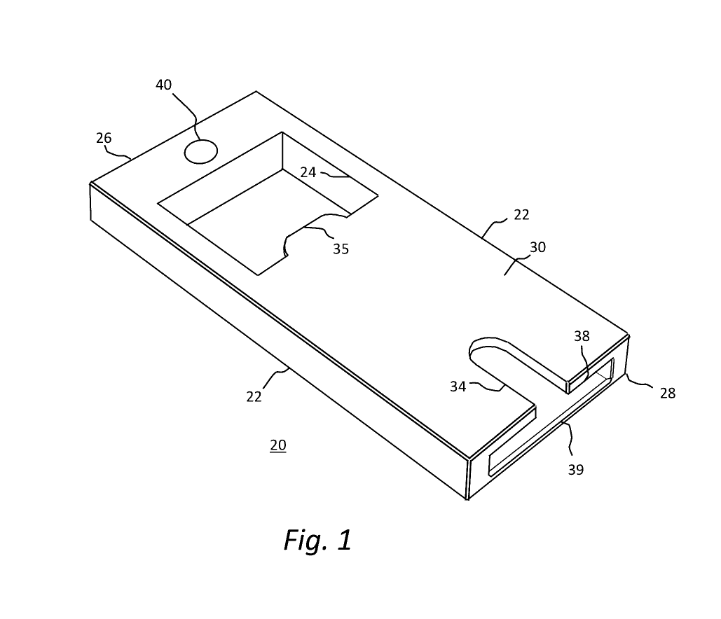

The invention will now be described with reference to FIG. 1, which illustrates in perspective view a first exemplary embodiment of the soup can and bottle opener in accordance with the present invention, shown generally at 20, having first and second sides 22, a window 24, a back end 26, a front end 28, a top face 30, and a bottom face (not shown). The top face 30 has a channel 34 extending rearward from the front end 28. A tooth 35 projects rearward from the top face 30 into the window 24. An eyelet 40 penetrates the opener from the top face 30 to the bottom face (not shown) close to the back end 26. A tab engaging cavity 38 is cut into the front end 28 and extends rearward within the opener. As can be seen, the tab engaging cavity 38 communicates with the channel 34. The tab engaging cavity 38 has a beveled lower lip 39, which behaves like a wedge, enabling a pull tab of a soup can to slide smoothly into the tab engaging cavity 38 when the opener is engaged thereon.

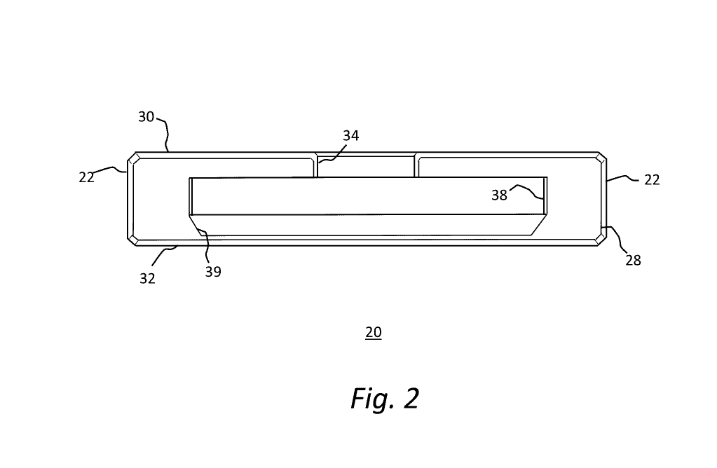

FIG. 2, a front view, shows the first and second sides 22, front end 28, top face 30, bottom face 32, channel 34, tab engaging cavity 38, and beveled lower lip 39. Indeed, all outer edges and corners of the front end 28 are beveled, increasing the comfort with which a user handles the opener and reducing the likelihood that any part of the opener will dig in or hang up and mechanically interfere with the process of engaging the opener on the soup can tab.

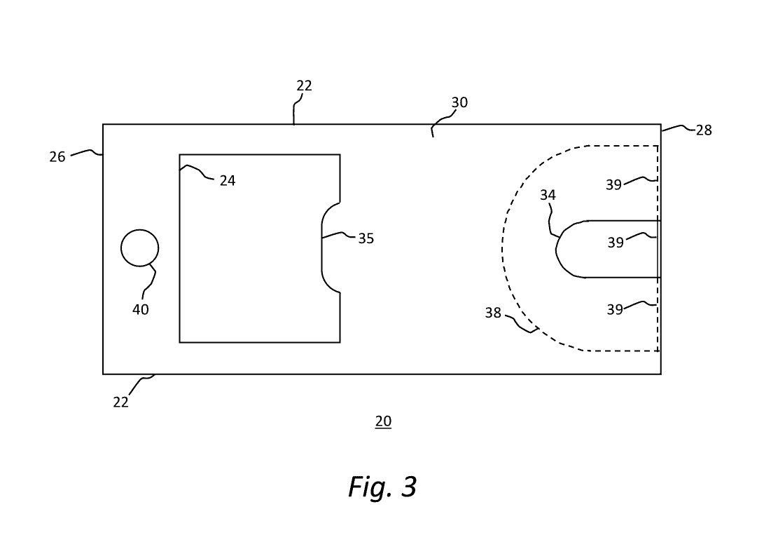

FIG. 3, a top plan view, shows the first and second sides 22, window 24, back end 26, front end 28, top face 30, tooth 35, channel 34, and tab engaging cavity 38 (drawn in dotted line) with beveled lower lip 39 (drawn in solid line where visible through the channel 34, drawn in dotted line where obscured by the top face 30).

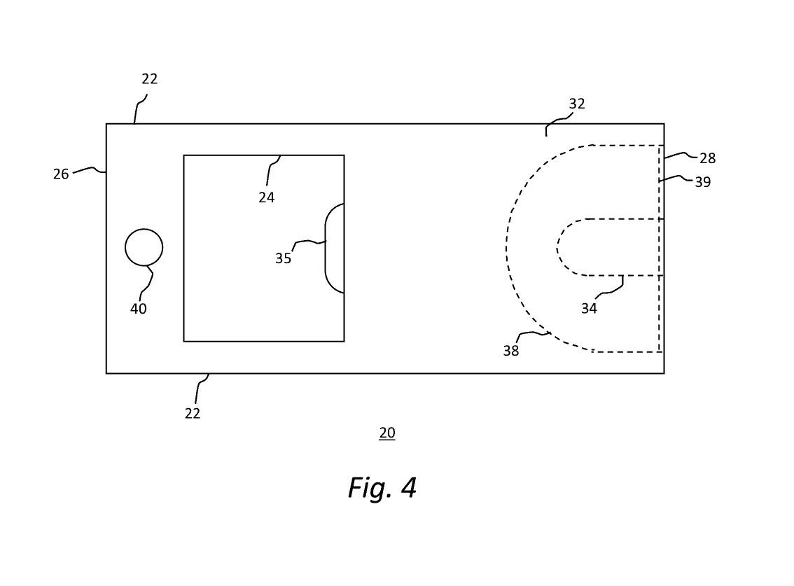

FIG. 4, a bottom plan view of the embodiment of FIG. 1, shows the first and second sides 22, window 24, tooth 35, back end 26, front end 28, bottom face 32, channel 34 (dotted line), and tab engaging cavity 38 (dotted line) with beveled lower lip 39 (dotted line).

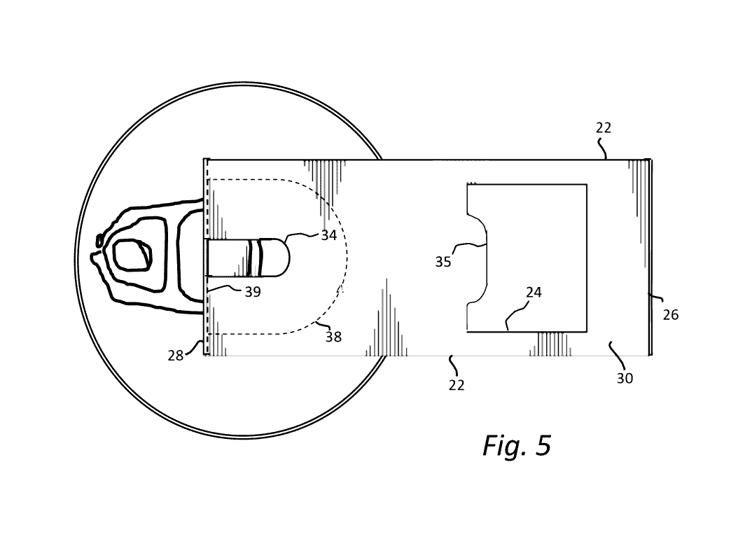

FIG. 5, a perspective view from above of the embodiment of FIG. 1 in use on a soup can, shows the top face 30, rear end 26, front end 28, channel 34, beveled lower lip 39 (parts of which are drawn in dotted line, given that the opener is angled downward toward the can and therefore the top face 30 obscures the beveled lower lip 39 except for the portion thereof that is visible through the channel 34). As can be seen, the opener is oriented somewhat inclined from the horizontal with the front end 28 engaged on a pull tab of a can. The beveled lower lip 39 slices smoothly beneath the pull tab like a wedge and lifts the pull tab, enabling the pull tab to slide easily into the tab engaging cavity 38. The channel 34 allows the user to see the tab partially revealed as it is in the tab engaging cavity 38.

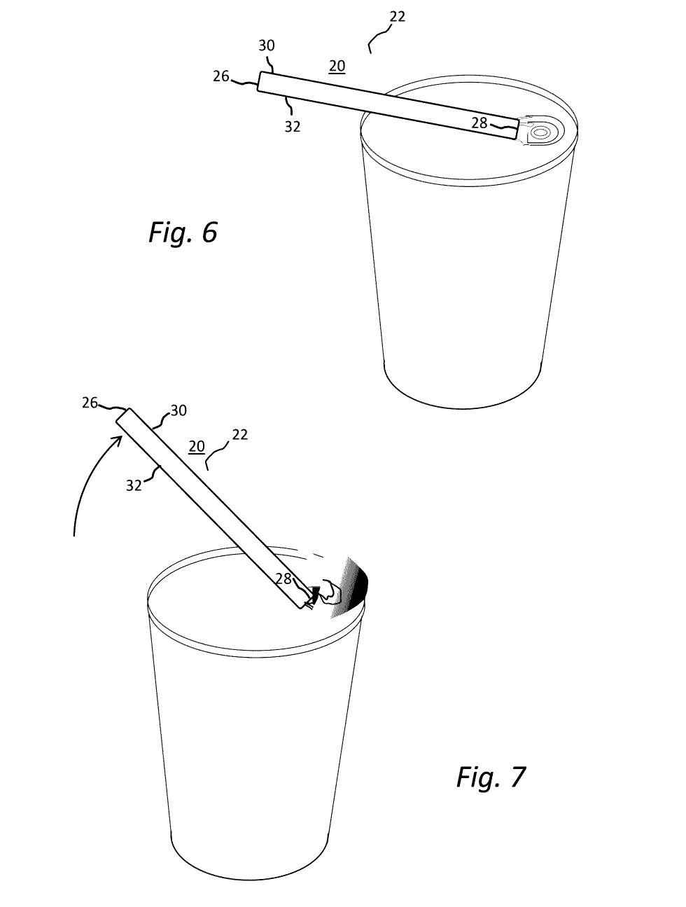

FIG. 6, a simplified perspective view from a side angle of the opener in use on a soup can, shows the top face 30, bottom face 32, side 22, rear end 26, and front end 28. The beveled lower lip 39 has already slid under the pull tab and the pull tab is contained within the tab engaging cavity (not drawn in this figure).

FIG. 7 shows the opener as in FIG. 6 after the opener has been rotated a substantial angle from the horizontal while the front end 28 was engaged on the pull tab, operating the tab in the manner intended to open the soup can. Under the force resulting from this rotation, a portion of the edge of the lid on the top of the soup can has broken free of the rim of the soup can in the manner intended by the soup can manufacturer. In FIG. 7, shadowing is used to suggest that the tab edge is bent down into the can. However, other modes of breakage and separation of the can top may be contemplated and are facilitated by the opener in accordance with the present invention. After the can top has been suitably broken or separated, the opener can be disengaged from the pull tab, which will be angled upward and can be grasped easily for the purpose of completing separation of the lid from the soup can if such is the intended mode of operation for the can in question.

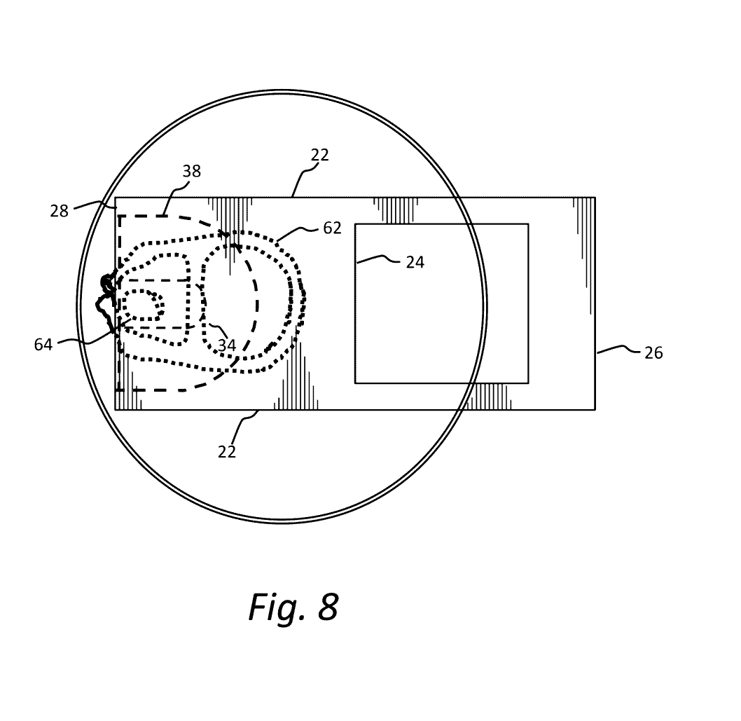

With reference to FIG. 8, another perspective view from above showing the opener inverted relative to the orientation shown by FIG. 5, it can be appreciated that, when lifting the opener after it has been engaged on a tab of a can, a user may wish not only to break the seal of an openable portion of the top of the can by levering the tab about its attachment to the top of the can, but also (or alternatively) to pull the tab upward, away from the top of the can, either to enlarge the opening that is created or, if the tab is attached to the openable portion of the top of the can, to begin completely removing the openable portion from the top. In this situation, the user may want to accomplish as much as possible with a single movement by lifting the tab a considerable distance from the top in one simple motion. To do this, the user may prefer to advance the front end 28 forward, beyond the location of the tab's attachment to the top of the can, so that, when the user lifts the rear end 26 of the opener and the opener rotates, the tab is far enough back into the tab engaging cavity 38 that it is lifted upward a good distance.

To take advantage of the structure of the opener in accordance with the present invention for this purpose, the user may invert the opener, so that the channel 34 faces the top of the can. With the opener inverted, the user engages the opener on the tab and advances the opener until the tab has traveled deep into the tab engaging cavity 38. In the process, the channel 34 accommodates the structure that attaches the tab to the top of the can, allowing the tab to travel deep into the tab engaging cavity 38. The front end 28 now contacts the soup can and creates a fulcrum at a point beyond the structure that attaches the tab to the can top. When the user rotates the opener upward, the tab is deeply engaged in the tab engaging cavity 38; thus, the opener lifts the tab upward a substantial distance.

Because the lip 39, which is now “on top of” the tab, is beveled, it reduces the likelihood that the tab will jam on the lip 39 and increases the likelihood that it will enter the tab engaging cavity 38 smoothly. Contrastingly, were the opener not inverted, and the channel 34 not facing the top of the can, the lip 39 would impinge on the structure that attaches the tab to the top of the can, halting further forward advancement of the opener onto the tab.

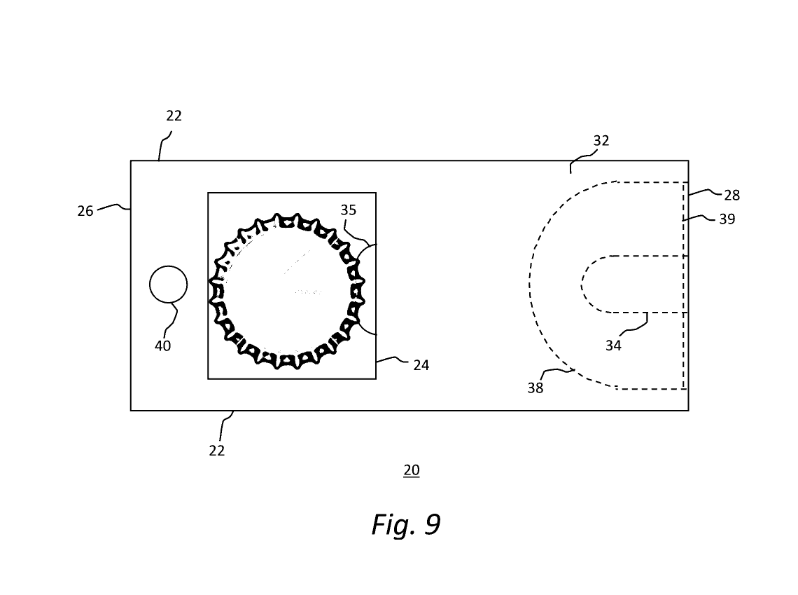

FIG. 9 shows the opener inverted, essentially in the bottom plan view of FIG. 4, with the cap of a beverage bottle located in the window 24 with the cap advanced toward the viewer until it is just beyond the tooth 35 and moved laterally toward the tooth so that the tooth is inserted beneath the rim of the bottle cap. As a practical matter, this is accomplished by angling the bottle relative to the opener, inserting the cap to a point just past the tooth, and then rotating the bottle toward a 90-degree angle relative to the opener, whereupon it encounters resistance as the bottle cap lodges in the window. At this stage, the opposite rim of the bottle cap rests against the window 24 near the back end 26. To open the bottle, the opener is lifted and rotated relative to the bottle, whereupon the tooth 35 pries the rim of the bottle cap off of the bottle.

With reference to FIGS. 1-9, the opener is formed of metal such as mild steel, stainless steel, brass, or hardened aluminum alloy, from which it is molded or machined. Of course, the greater the tensile strength and hardness of the metal, the more durable the opener, especially as it engages metallic caps of bottles. Also with reference to FIGS. 1-8, the opener has dimensions as follows:
Eyelet 40, if present: between 0.2 inch and 0.4 inch.
Window 24, width: 1.125 inch.
Window 24, length: 0.70 inch.
Tooth 35, width: 0.45 inch.
Tooth 35, length (extent of projection rearward into window): 0.15 inch.
Overall length of opener (from back end 26 to front end 28): from 4.0 inch to 6.0 inch.
Tab-engaging cavity 38, height: approximately 0.2 inch.
Tab-engaging cavity 38, depth from front end 28 extending toward back end 26: 1.0 inch.
Tab-engaging cavity 38, width at front end 28: 1.0 inch.
Material thickness between first or second side 22 and tab-engaging cavity 38 at front end 28: 0.25 inch.
Channel 34, width: 0.33 inch.
Channel 34, length: 0.75 inch.
Thickness of material from top face 30 to tab engaging cavity 38 and from tab engaging cavity to bottom surface 32: approximately 0.05 inch.
Opener height from top face 30 to bottom face 32: 0.30 inch.

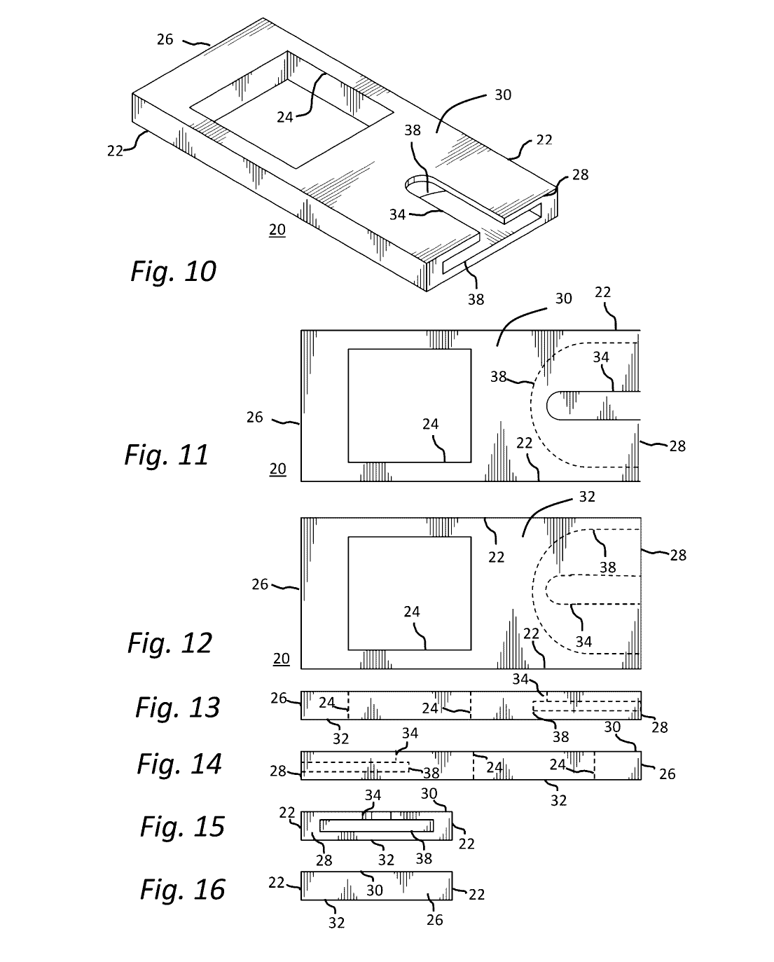

FIG. 10, a perspective view of a second exemplary embodiment of the opener in accordance with the present invention, shows an opener dimensioned for opening a tab-equipped beverage can. The opener has first and second sides 22, window 24, back end 26, front end 28, top face 30, and channel 34. A tab receiving cavity 38 is cut into the front end 28 and extends rearward within the opener. As can be seen, the tab receiving cavity 38 communicates with the channel 34. Because the tab of a beverage can is often smaller than that of a soup or food can, this second embodiment of the opener has a longer, narrower channel 38 and is generally smaller and of lighter construction than that of the first exemplary embodiment. It should be appreciated that the tooth 35 of the first exemplary embodiment may be added to the second exemplary embodiment and the dimensions of the window 24 may be altered to optimize performance opening a bottle.

FIG. 11, a top view of the embodiment of FIG. 9, shows the first and second sides 22, window 24, back end 26, front end 28, top face 30, and channel 34. The tab receiving cavity 38 is drawn in dotted line.

FIG. 12, a bottom view of the embodiment of FIG. 9, shows the first and second sides 22, window 24, back end 26, front end 28, bottom face 32, channel 34 (dotted line) and tab receiving cavity 38 (dotted line).

FIG. 13, a left side view of the embodiment of FIG. 9, shows the first side 22, window 24 (dotted lines), back end 26, front end 28, top face 30, bottom face 32, channel 34 (dotted lines) and tab receiving cavity 38 (dotted lines).

FIG. 14, a right side view of the embodiment of FIG. 9, shows the second side 22, window 24 (dotted lines), back end 26, front end 28, top face 30, bottom face 32, channel 34 (dotted lines) and tab receiving cavity 38 (dotted lines).

FIG. 15, a front view, shows the first and second sides 22, front end 28, top face 30, bottom face 32, channel 34 and tab receiving cavity 38.

FIG. 16, a rear view, shows the first and second sides 22, back end 26, top face 30 and bottom face 32.

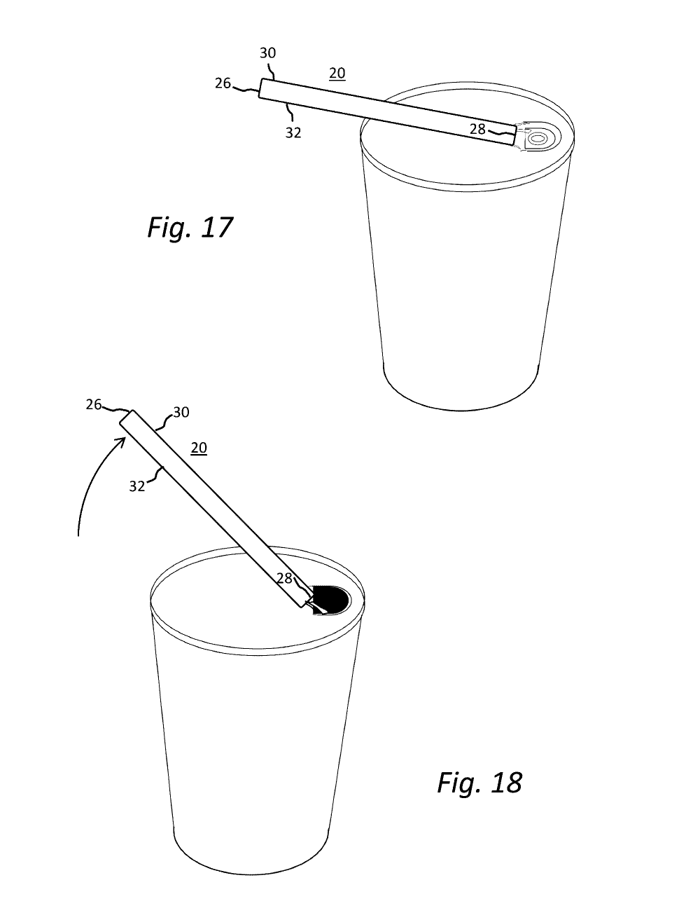

FIG. 17, a perspective view of the embodiment of FIG. 9 in use on a food or beverage can, shows the top face 30, bottom face 32, rear end 26, and front end 28. As can be seen, the opener is oriented somewhat inclined from the horizontal with the front end 28 engaged on a pull tab of a can.

FIG. 18, another perspective view of the embodiment of FIG. 9 in use on a food or beverage can, shows the top face 30, bottom face 32, rear end 26, and front end 28. As can be seen, the opener has been rotated a substantial angle from the horizontal while the front end 28 was engaged on the pull tab, operating the tab in the manner intended to open the can.

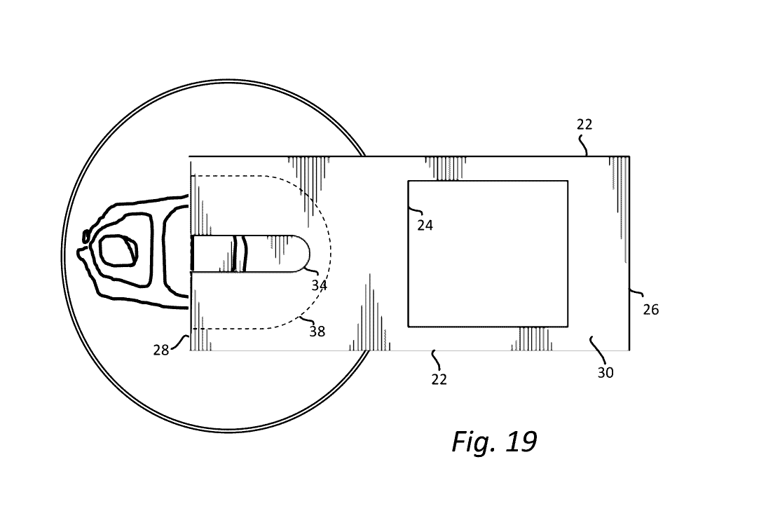

FIG. 19, a perspective view of the embodiment of FIG. 9, shows the first and second sides 22, window 24, back end 26, front end 28, top face 30, channel 34 and tab receiving cavity 38 (dotted line). The tab of the can is engaged in the tab receiving cavity 38 and is partially visible through the channel 34.

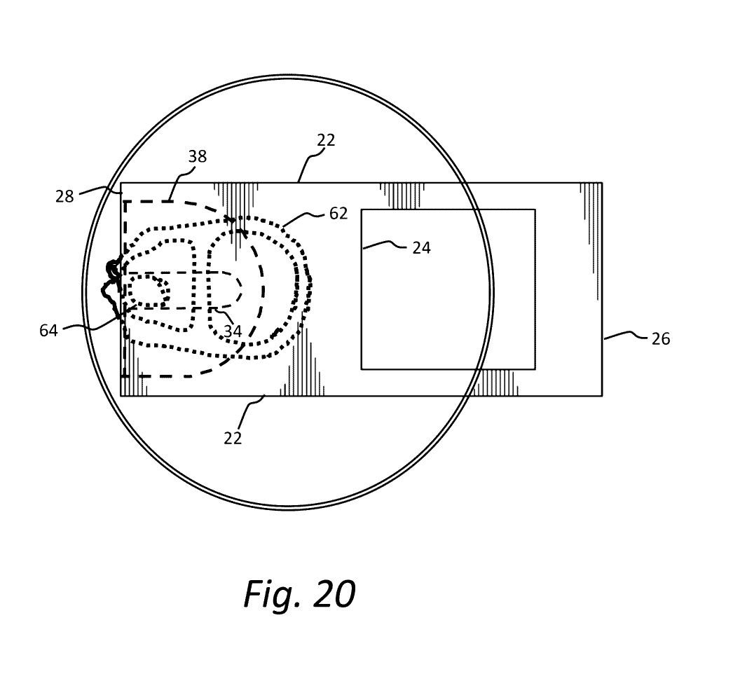

FIG. 20, another top view of the embodiment of FIG. 9 engaged on a tab of a can while inverted relative to FIG. 19, shows the first and second sides 22, window 24, back end 26, front end 28, top face 30, channel 34 (dotted line) and tab receiving cavity 38 (dotted line). The tab of the can, given the reference number 62, also shown in dotted line (except where unobscured by intervening structure of the opener), is engaged in the tab receiving cavity 38. An attaching structure, given the reference number 64, attaches the tab to the top of the can.

As FIG. 20 shows, it can be appreciated that, when lifting the opener after it has been engaged on a tab of a can, a user may wish not only to break the seal of an openable portion of the top of the can by levering the tab about its attachment to the top of the can, but also (or alternatively) to pull the tab upward, away from the top of the can, either to enlarge the opening that is created or, if the tab is attached to the openable portion of the top of the can, to begin completely removing the openable portion from the top. In this situation, the user may want to accomplish as much as possible with a single movement by lifting the tab a considerable distance from the top in one simple motion. To do this, the user may prefer to advance the front end 28 forward, beyond the location of the tab's attachment to the top of the can (attaching structure 64), so that, when the user lifts the rear end 26 of the opener and the opener rotates, the tab 62 is far enough back into the tab engaging cavity 38 to be lifted upward a good distance.

To take advantage of the structure of the opener in accordance with the present invention for this purpose, the user may invert the opener, so that the channel 34 faces the top of the can. With the opener inverted, the user engages the opener on the tab and advances the opener until the tab has traveled deep into the tab engaging cavity 38. In the process, the channel 34 accommodates the structure that attaches the tab to the top of the can, allowing the tab to travel deep into the tab engaging cavity 38. The front end 28 now contacts the soup can and creates a fulcrum at a point beyond the structure that attaches the tab to the can top. When the user rotates the opener upward, the tab is deeply engaged in the tab engaging cavity 38; thus, the opener lifts the tab upward a substantial distance.

With reference to FIGS. 10-20, the second exemplary embodiment of the opener in accordance with the present invention is formed of metal such as aluminum or aluminum alloy, from which it is molded or machined. Other metals, such as mild steel or brass, could be substituted. Of course, the greater the tensile strength and hardness of the metal, the more durable the opener, especially as it engages metallic caps of bottles.

Also with reference to FIGS. 10-20, the second exemplary embodiment of the opener in accordance with the present invention has dimensions as follows: eyelet, approximately 3/16 inch (0.48 cm) diameter; window 24 approximately 1 inch (2.54 cm) lengthwise and approximately ¾ inch (1.9 cm) wide; opener length (from back end 26 to front end 28) 2 and 5/16 inch (5.9 cm); tab-engaging cavity 38 height approximately 3/32 inch (0.24 cm); tab-engaging cavity 38 depth from front end 28 toward back end 26 approximately 1.0 inch (2.54 cm); tab-engaging cavity 38 width at front end 28 approximately ¾ inch (1.9 cm); material thickness between first or second side 22 and tab-engaging cavity 38 at front end 28 approximately ⅛ inch (0.32 cm); channel 34 width approximately 7/32 inch (0.56 cm); channel 34 length approximately ¾ inch (1.9 cm); thickness of material from top face 30 to tab engaging cavity 38 approximately 3/32 inch (0.24 cm); opener height from top face 30 to bottom face 32 approximately ¼ inch (0.635 cm). The key ring 36 is of the commonly available variety, generally circular in shape, formed of spring steel, overlapping in a spiral configuration, able to be spread open for the purposes of adding or removing an object such as a key, typically having a diameter of between 2.0 and 3.0 cm.

As to any imperfection in the scaling and proportion of the drawing figures, it should be understood that minor adjustments in proportion, dimension and angle can be made to optimize performance and manufacture.

As can be seen from the drawing figures and from the description, each embodiment of the opener in accordance with the present invention solves a problem by addressing the need for an opener for various food or beverage containers.

While the specification describes particular embodiments of the present invention, those of ordinary skill can devise variations of the present invention without departing from the inventive concept.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one.

Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment. In this provisional application for patent, the description is to be regarded as incorporating the subject matter of the claims.

1. A beverage and food container opener, comprising:
first and second sides, top and bottom faces, and front and back ends, said sides, faces and ends roughly defining a rigid rectangular solid;
a soup can tab-engaging cavity formed in said front end; and
a channel formed in said top face over said tab-engaging cavity;
said channel and said tab-engaging cavity being functional together to lift the soup can tab and facilitate opening the soup can.

2. Apparatus as set forth in claim 1, having a window formed through said opener from said top face to said bottom face proximate said back end, said window having an inward-projecting tooth, said window and said tooth being usable together to pry a cap from a beverage bottle.

3. Apparatus as set forth in claim 1, having an eyelet formed from said top face to said bottom face proximate said back end.

4. Apparatus as set forth in claim 1, wherein said tab-engaging cavity has a beveled lip.

5. A method of opening a tab-equipped soup can, said method including the steps of:
providing an opener as set forth in claim 1 above;
positioning said tab-engaging cavity about the tab; and
rotating said opener until the tab opens the can.

6. The method of claim 5, further including the steps of orienting the opener with said channel away from the tab before engaging the opener on the tab and rotating the opener by lifting said back end after said front end becomes difficult to advance any farther relative to the tab.

7. The method of claim 5, further including the steps of orienting the opener with said channel toward the tab before engaging the opener on the tab, advancing the opener until said front end has advanced past the structure that attaches the tab to the can top, and, thereafter, rotating the opener by lifting said back end.

8. A method of opening a capped bottle, said method including the steps of:
providing an opener as set forth in claim 2 above;
positioning said window about the cap of the bottle; and
rotating said opener until the cap is pried off the bottle.
